(19) United States
(12) Patent Application Publication
(10) Pub. No.: US 2018/0013779 A1
(43) Pub. Date: Jan. 11, 2018

(54) METHODS AND APPARATUSES FOR INTEGRITY VALIDATION OF REMOTE DEVICES USING SIDE-CHANNEL INFORMATION IN A POWER SIGNATURE ANALYSIS

(71) Applicant: Power Fingerprinting Inc., Vienna, VA (US)

(72) Inventors: Carlos R. Aguayo Gonzalez, Reston, VA (US); Jeffrey H. Reed, Blacksburg, VA (US); Steven C. Chen, Potomac, MD (US)

(73) Assignee: Power Fingerprinting Inc., Vienna, VA (US)

(21) Appl. No.: 15/639,918

(22) Filed: Jun. 30, 2017

Related U.S. Application Data
(60) Provisional application No. 62/359,045, filed on Jul. 6, 2016.

(51) Int. Cl. H04L 29/06; H04L 9/00

(52) U.S. Cl. CPC H04L 63/1425; H04L 63/061; H04L 9/003; H04L 63/0861

(57) ABSTRACT

Some embodiments described herein include an apparatus having a processor communicatively coupled to a memory. The processor is configured to send, at a first compute device, input vectors to a second compute device. The processor is configured to receive side-channel information, from the second compute device, in response to the input vectors. The processor is then configured to compare the received side-channel information with predefined side-channel information associated with the second compute device. If the received side-channel information does not match the predefined side-channel information, the processor is configured to generate a message that the second compute device has an anomaly.

### CROSS-REFERENCE TO RELATED APPLICATIONS

This application is non-provisional of and claims priority under 35 U.S.C. §119 to U.S. provisional application Ser. No. 62/359,045, filed Jul. 6, 2016, entitled “Methods and Apparatuses for Integrity Validation of Remote Devices Using Side-channel Information in a Power Signature Analysis.”

This application is related to U.S. patent application Ser. No. 13/883,105, having a 35 U.S.C. §371(c) date of Aug. 15, 2013, entitled “Using Power Fingerprinting (PFP) To Monitor The Integrity And Enhance Security Of Computer Based Systems.”

The aforementioned applications are all herein expressly incorporated by reference in their entirety.

### BACKGROUND

Some embodiments described herein relate generally to methods and apparatus to use side-channel information in a power signature analysis to validate integrity of remote electronic devices.

When an electronic device exchanges data with a remote electronic device, known authentication techniques typically rely on authentication keys that are known to both devices. The exchange of data is accompanied by the exchange of the authentication keys to validate the devices' integrity. Dynamic and static code analysis can also be used to validate the devices' integrity. The complexity of the process, disruption to the remote device's function, and bandwidth limitation, however, typically make such techniques costly and impractical.

In addition, the known authentication techniques validate that the data communication is destined to an intended recipient or an authorized user. These authentication techniques and current encryption techniques, however, are unable to identify, for example, if the software running on that device has been compromised, if the hardware has been compromised, or if the software is licensed to use in a specific hardware platform. Authentication and/or encryption techniques can be negated if malware is monitoring the execution and stealing or modifying the decrypted information.

Accordingly, a need exists for methods and apparatuses to validate integrity of a remote device without disruption to the remote device's functions and with less burden on the bandwidth. A need also exists for methods and apparatus to an improved authentication and encryption mechanism such that the code will not be decrypted if malware is also running on the device.

### SUMMARY

Some embodiments described herein include an apparatus having a processor communicatively coupled to a memory. The processor is configured to send, at a first compute device, input vectors to a second compute device. The processor is configured to receive side-channel information, from the second compute device, in response to the input vectors. The processor is then configured to compare the received side-channel information with predefined side-channel information associated with the second compute device. If the received side-channel information does not substantially match the predefined side-channel information, the processor is configured to generate a message that the second compute device has an anomaly.

Some embodiments described herein include an apparatus having a processor communicatively coupled to a memory. The processor is configured to execute, at a compute device, a first section of code and measure the side-channel information. The processor is configured to convert the side-channel information to a first encryption key and encrypt a second section of code with the first encryption key to produce an encrypted second section of code. The processor is then configured to execute, at the compute device, the second section of code and measure the side-channel information. The processor is configured to convert the side-channel information for the second section of code to a second encryption key and encrypt a third section of code with the second encryption key to produce an encrypted third section code. Optionally, the processor is configured to aggregate the encrypted second section of code and the encrypted third section of code. The processor is configured to repeat the above steps with each section of code until each section of code from a block of code is encrypted.

Some embodiments described herein include an apparatus having a processor communicatively coupled to a memory. The processor is configured to execute, at a compute device, a first section of code and measure side-channel information. The processor is configured to convert the side-channel information to a first decryption key and decrypt a second section of code with the first decryption key. The processor is configured to execute, at the compute device, the second section of code and measure the side-channel information. The processor is configured to convert the side-channel information for the second section of code to a second decryption key and decrypt a third section of code with the second decryption key. The processor is configured repeat the above steps with each section of code until each section of code from a block of code is decrypted.

### BRIEF DESCRIPTION OF THE DRAWINGS

FIG. 1 is a schematic diagram illustrating two compute devices communicating via a network, according to an embodiment.

FIG. 2 is a schematic diagram illustrating a compute device including an authentication controller and an encryption and decryption controller, according to an embodiment.

FIG. 3 is a flow chart illustrating a method to validate integrity of a remote device using side-channel information, according to one embodiment.

FIG. 4 is a flow chart illustrating a method to encrypt data using side-channel information, according to an embodiment.

FIG. 5 is a flow chart illustrating a method to decrypt data using side-channel information, according to an embodiment.

FIG. 6 is a graph showing reflected electromagnetic emission signals from a pre-determined trusted device and a pre-determined counterfeit device, according to an embodiment.

FIG. 7 is a graph showing error signals between an expected response and an observed response for a pre-determined trusted device and a pre-determined counterfeit device, according to an embodiment.

FIG. 8 is a graph showing error distributions of a pre-determined trusted device and a pre-determined counterfeit device, according to an embodiment.

FIG. 9 is a flow chart showing a process of detector design, according to an embodiment.

FIG. 10 is a graph showing sample probability distribution from trusted code execution used for detector design and threshold selection, according to an embodiment.

### DETAILED DESCRIPTION

Some embodiments described herein include an apparatus having a processor communicatively coupled to a memory. The processor is configured to send, at a first compute device, input vectors to a second compute device. The processor is configured to receive side-channel information, from the second compute device, in response to the input vectors. The processor is then configured to compare the received side-channel information with predefined side-channel information associated with the second compute device. If the received side-channel information does not substantially match the predefined side-channel information, the processor is configured to generate a message that the second compute device has an anomaly.

Some embodiments described herein include an apparatus having a processor communicatively coupled to a memory. The processor is configured to execute, at a target device, a first section of code and measure the side-channel information. The processor is configured to convert the side-channel information to a first encryption key and encrypt a second section of code with the first encryption key to produce an encrypted second section of code. The processor is then configured to execute, at the target device, the second section of code and measure the side-channel information. The processor is configured to convert the side-channel information for the second section of code to a second encryption key and encrypt a third section of code with the second encryption key to produce an encrypted third section code. Optionally, the processor is configured to aggregate the encrypted second section of code and the encrypted third section of code. The processor is configured to repeat the above steps with each section of code until each section of code from a block of code is encrypted.

Some embodiments described herein include an apparatus having a processor communicatively coupled to a memory. The processor is configured to execute, at a target device, a first section of code and measure side-channel information. The processor is configured to convert the side-channel information to a first decryption key and decrypt a second section of code with the first decryption key. The processor is configured to execute, at the target device, the second section of code and measure the side-channel information. The processor is configured to convert the side-channel information for the second section of code to a second decryption key and decrypt a third section of code with the second decryption key. The processor is configured repeat the above steps with each section of code until each section of code from a block of code is decrypted.

As used in this specification, the singular forms “a,” “an” and “the” include plural referents unless the context clearly dictates otherwise. Thus, for example, the term “a compute device” is intended to mean a single compute device or multiple compute devices. For another example, the term “a decryption key” can mean a single decryption key or multiple decryption keys.

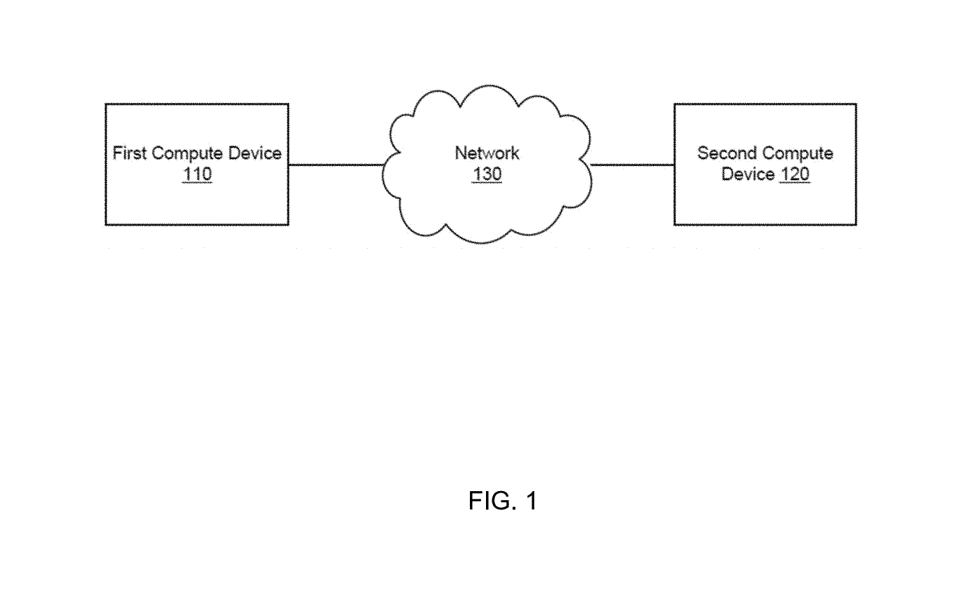

FIG. 1 is a schematic diagram illustrating two compute devices communicating via a network, according to an embodiment. The first compute device 110 and the second compute device 120 can be or include, for example, computers, cell phones, digital cameras, tablets, electrical circuit boards, electronic circuit(s), and/or electronic component(s). The electronic device(s) (e.g., computer(s), cell phone(s), digital camera(s), etc.) can include analog circuits and/or digital circuits. The electronic circuit(s) can include, for example, critical embedded systems, coprocessors, and field-programmable gate arrays (FPGAs). The first compute device 110 can be configured to, among other functions, receive data and/or information, and send data, commands, and/or instructions to the second compute device 120, via the network 130. Similarly, the second compute device 120 can be configured to, among other functions, receive data and/or information, and send data, commands, and/or instructions to the first compute device 110, via the network 130.

As shown in FIG. 1, the network 130 can be any network or combination of networks capable of transmitting communication information (e.g., data and/or signals) and can include, for example, a telephone network, an Ethernet network, a fiber-optic network, a wireless network, and/or a cellular network. The communication information can be transmitted over a wireless network, such as, for example, a Wi-Fi® or wireless local area network (“WLAN”) connection, a wireless wide area network (“WWAN”) connection, and/or a cellular connection. A network connection can be a wired connection such as, for example, an Ethernet connection, a digital subscription line (“DSL”) connection, a broadband coaxial connection, and/or a fiber-optic connection.

In some embodiments, a compute device (the first compute device 110 or the second compute device 120 as shown in FIG. 1) can monitor itself for integrity validation. The integrity of the compute device can be compromised, for example, by malicious intrusions, unauthorized modifications to the hardware or the software of the compute device, and tampering in the compute device (i.e., anomaly). In some instances, a physical side-channel (e.g., indirect measure of program execution such as power consumption, electromagnetic emissions, and other physical signals such as current, voltage, temperature, vibration, light, delay, impedance, vibration, pressure, global positioning system coordinates, and/or the like) can be used to assess the execution status of a compute device (e.g., digital circuit or computer system) using a monitor and to detect when an unauthorized execution has managed to disrupt or modify the normal operation of the compute device. This process of detecting program execution anomaly is referred herein as “fingerprinting analysis” or “signature analysis”; methods and apparatuses that implement fingerprinting can be referred to as a fingerprinting system or a system, which can be embodied in a number of different ways and forms. In some instances, such fingerprinting analysis can use, for example, a physical side channel to detect an anomaly in the operation of a compute device or system. An example of a fingerprinting system is discussed in U.S. patent application Ser. No. 13/883,105, having a 35 U.S.C. §371(c) date of Aug. 15, 2013, entitled “Using Power Fingerprinting (PFP) To Monitor The Integrity And Enhance Security Of Computer Based Systems.” An example of a side-channel monitoring system is discussed in U.S. patent application Ser. No. 14/720,497, filed on May 22, 2015, entitled “Systems, Methods, and Apparatuses For Intrusion Detection And Analytics Using Power Characteristics Such As Side-Channel Information Collection,” which is incorporated herein by reference. In such embodiments, when an anomaly is detected, the compute device can implement remedial processes, such as shutting down the target device, notifying an entity of the anomaly, or resetting the compute device to a known state.

In other embodiments, the integrity of a compute device can be assessed by a remote compute device that is communicatively coupled to the compute device, using side-channel information in a power signature analysis. For example, as shown in FIG. 1, the first compute device 110 can be configured to validate the integrity of the second compute device 120 using side-channel information such that the operation of the second compute device 120 is not disrupted and the exchange of the side-channel information between the first compute device 110 and the second compute device 120 imposes less burden on the bandwidth of the communication via the network 130. Specifically, the first compute device 110 can send to the second compute device 120, via the network 130, a set of inputs (or input vectors) that activates the second electronic device 120 or specifically focuses on (or activates) a portion of the second electronic device 120 (e.g., less than the entirety of the second electronic device 120). In other implementations, the set of inputs can execute a software code or part of the software code. The inputs can include code to be executed on the second electronic device 120. In some instances, the set of inputs (or input vectors) are selected to activate the second electronic device and check the outputs (i.e., side-channel information of the second electronic device) against predefined values (i.e., predefined side-channel information of the second electronic device.)

In one implementation, for example, a user or a test engineer can specify particular test inputs. Alternatively, the first compute device 110 can select a predefined list of inputs in a predefined order. The second compute device 120 can include a detector (not shown in FIG. 1) configured to measure side-channel information (such as temperature, power, electromagnetic (EM) emissions, circuit delay, and/or the like) in response to the set of inputs received from the first compute device 110. The second compute device 120 can send the side-channel information to the first compute device 110 via the network 130 for integrity validation.

The first compute device 110 can compare the received side-channel information (or discriminatory features of the received side-channel information) with predefined side-channel information (or discriminatory features of the predefined side-channel information) associated with the second compute device 120 in response to the set of input vectors. The predefined side-channel information can be associated with a trusted second compute device or an unauthorized second compute device. When the received side-channel information substantially matches the predefined side-channel information associated with a trusted second compute device, the second compute device can be determined to be trusted (or authorized, or verified). When the received side-channel information does not substantially match the predefined side-channel information associated with a trusted second compute device, the second compute device can be determined to be unauthorized (or untrusted or unverified). The received side-channel information substantially matches predefined side-channel information when the differences of certain discriminatory feature(s) in the received side-channel information and the predefined side-channel information are within a predefined range (e.g., a threshold). Remedial actions (such as sending a signal from the first compute device to the second compute device to shut down the second compute device, to notify a third entity, or to reset the second compute device to a known state) can be triggered when the second compute device is determined to be unauthorized.

In some embodiments, the first compute device 110, before transmitting data (e.g., a set of sections of code) to the second compute device 120 via the network 130, can encrypt the data with encryption keys. The encryption keys can be derived based on the side-channel information collected when a certain section of code is executed at the first compute device 110. Upon receiving the encrypted data from the first compute device 110, the second compute device 120 can decrypt the encrypted data based on the side-channel information collected when a certain section of code is executed at the second compute device 120. When the second compute device 120 is a trusted device, the decryption keys derived from the side-channel information collected the second compute device 120 can be used to decrypt the data for further processing at the second compute device 120. When the second compute device 120 is not a trusted device, the decryption keys derived from the side-channel information collected the second compute device 120 will fail to decrypt the data from the first compute device 110, and therefore the second compute device 120 will not read the data. When other unexpected software such as malware is running concurrently with the execution of the desired code, it can cause a substantial change (or sufficiently observable change) in the side channel information such that the decryption key cannot be recovered. As a result, the software will not be executed further to prevent information from being revealed to malware or hardware Trojan.

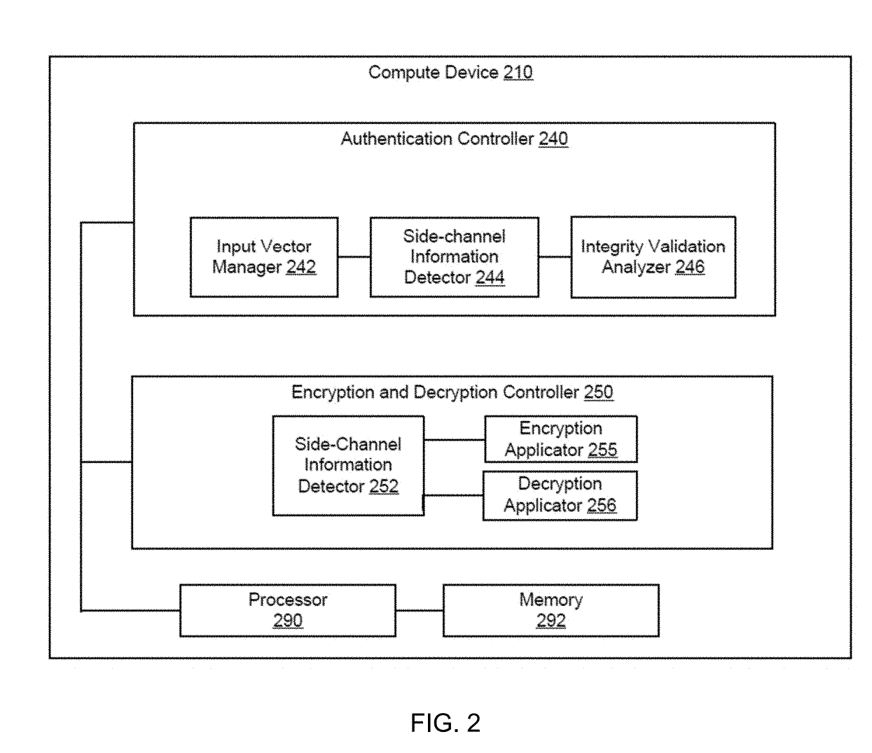

FIG. 2 is a schematic diagram illustrating a compute device including an authentication controller and an encryption and decryption controller, according to an embodiment. The compute device 210 can be an example of the first compute device 110 or the second compute device 120 shown in FIG. 1. As discussed above, the compute device 210 can include, for example, computers, cell phones, digital cameras, tablets, electrical circuit boards, electronic circuit(s), and/or electronic component(s). The compute device 210 can include analog circuits and/or digital circuits. The compute device 210 can include, for example, critical embedded systems, coprocessors, and field-programmable gate arrays (FPGAs). The compute device 210 can be configured to, among other functions, receive data and/or information, and send data, commands, and/or instructions to another compute device (not shown in FIG. 2) via a network.

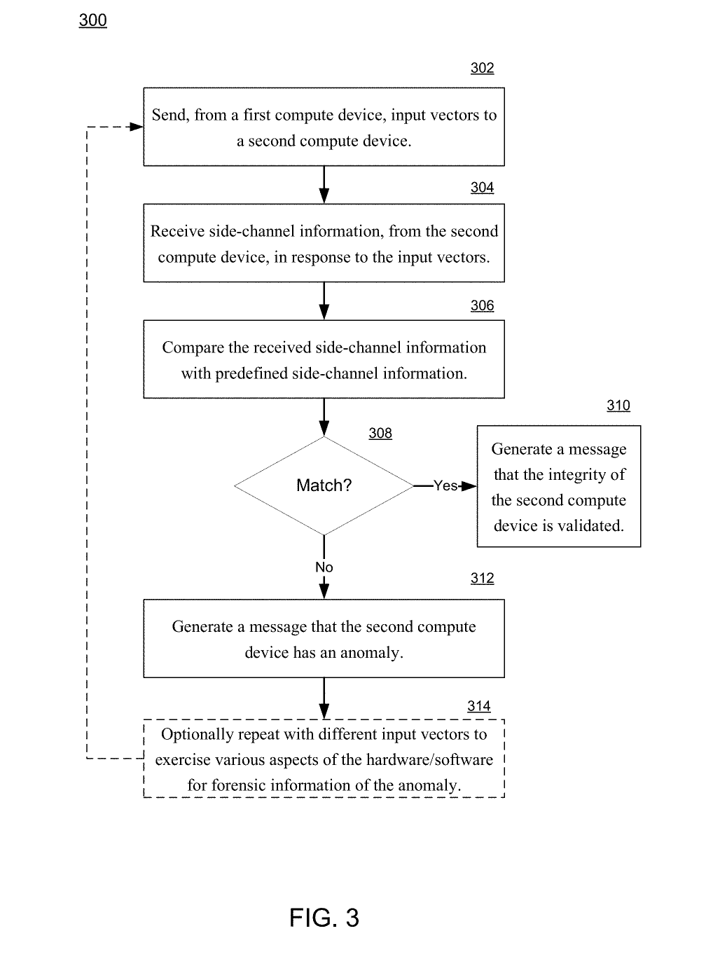

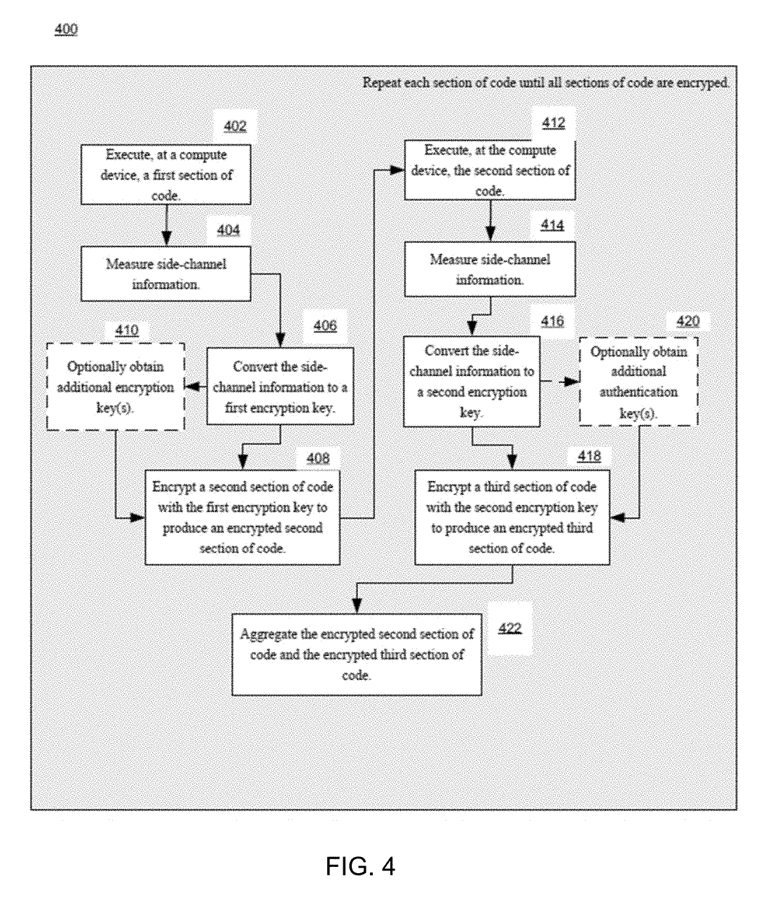

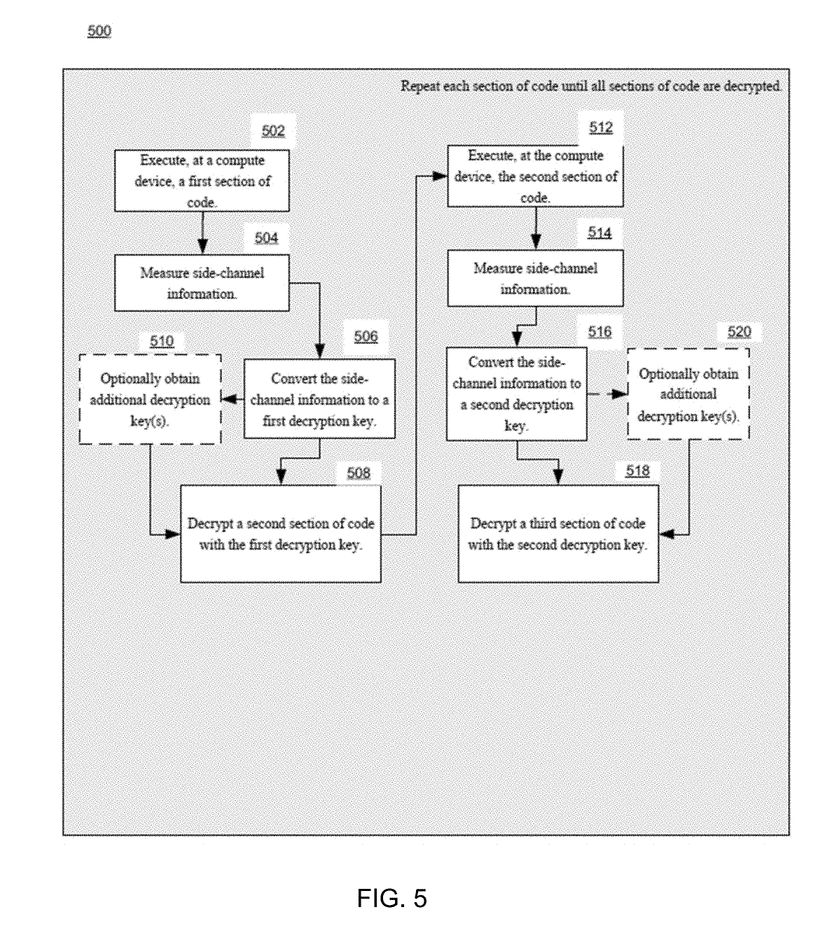

As shown in FIG. 2, the compute device 210 includes a processor 290, a memory 292, an authentication controller 240, and an encryption and decryption controller 250. In some implementations, the compute device 210, including the authentication controller 240, and the encryption and decryption controller 250 can be a single physical device. In other words, the authentication controller 240 and the encryption and decryption controller 250 can be components within the compute device 210 or on a common chip of the compute device 210. In such implementations, the compute device 210 can perform the authentication process, the encryption process, and the decryption process described herein on the compute device 210 or on the chip within which they are located. This allows the authentication process, the encryption process, and the decryption process to be self-contained with the compute device 210 or the chip such that external processes or devices need not be involved in the performance of the authentication process or the encryption and decryption process described herein. Similarly stated, in such implementations, the authentication method as discussed herein in FIG. 3, the encryption method as discussed in FIG. 4, and the decryption method as discussed herein in FIG. 5, can be performed by the same compute device 210.

In other implementations, the authentication controller 240 and the encryption and decryption controller 250 can be a single physical device or multiple physical devices external to the compute device 210 and operatively coupled by a network. Each of the authentication controller 240 and the encryption and decryption controller 250 can include one or multiple modules and/or components shown in FIG. 2. In yet other implementations, the authentication controller 240 can be a single physical device external to the compute device 210 while the encryption and decryption controller 250 is a component within the compute device 210. In yet other implementations, the encryption and decryption controller 250 can be a single physical device external to the compute device 210 while the authentication controller 240 is a component within the compute device 210.

Each module or component in the compute device 210 can be operatively coupled to each remaining module and/or component, for example, by a communication bus (not shown in FIG. 2). Each module and/or component in the compute device 210 can be any combination of hardware and/or software (stored and/or executing in hardware) capable of performing one or more specific functions associated with that module and/or component.

The memory 292 can be, for example, a random-access memory (RAM) (e.g., a dynamic RAM, a static RAM), a flash memory, a removable memory, a hard drive, a database and/or so forth. In some implementations, the memory 292 can include (or store), for example, a database, process, application, virtual machine, and/or some other software modules (stored and/or executing in hardware) or hardware modules configured to execute an authentication process, an encryption process, a decryption process and/or one or more associated methods. In such embodiments, instructions for executing the authentication process, the encryption process, the decryption process and/or the associated methods can be stored within the memory 292 and executed at the processor 290. In some implementations, data can be stored in the memory 292 including for example data related to the compute device, its measured characteristics and its simulated characteristics.

The processor 290 (e.g., a general-purpose processor, a field programmable gate array (FPGA), an application specific integrated circuit (ASIC), etc.) can be configured to control, for example, the operations of writing data into and reading data from the memory 292, and executing the instructions stored within the memory 292. The processor 290 can also be configured to execute and/or control, for example, the operations of the authentication controller 240 and the encryption and decryption controller 250, as described in further detail herein. In some implementations, under the control of the processor 290 and based on the methods or processes stored within the memory 292, the authentication controller 240 and the encryption and decryption controller 250 can be configured to execute an authentication process, an encryption process, a decryption process, as described in further detail herein.

Each of the authentication controller 240 and the encryption and decryption controller 250 can be implemented in hardware (e.g., critical embedded systems, coprocessors, and field-programmable gate arrays (FPGAs)) and/or software (e.g., stored in a memory such as the memory 292 and/or executing in hardware such as the processor 290). Each of the authentication controller 240 and the encryption and decryption controller 250 can be operatively coupled to each remaining module and/or component.

As shown in FIG. 2, the authentication controller 240 includes an input vector manager 242, a side-channel information detector 244, and an integrity validation analyzer 246. In some implementations, the authentication controller 240 includes a processor and a memory. In some implementations, the authentication controller 240 can be a single physical device. In other implementations, the authentication controller 240 can include multiple physical devices (e.g., operatively coupled by a network), each of which can include one or multiple modules and/or components shown in FIG. 2. Each component of the input vector manager 242, the side-channel information detector 244, and the integrity validation analyzer 246 in the authentication controller 240 can be operatively coupled to each other in the authentication controller 240. Each component of the input vector manager 242, the side-channel information detector 244, and the integrity validation analyzer 246 in the authentication controller 240 can be any combination of hardware and/or software (stored and/or executing in hardware) capable of performing one or more specific functions associated with that component. Specially, the side-channel information detector 244 can include a physical hardware (e.g., sensor) to measure side-channel information (such as temperature, power, EM emissions, circuit delay, and/or the like) of the compute device 210.

The input vector manager 242 can select inputs (or input vectors) for both electrical test and simulation test that activates a compute device or specifically focuses on (or activates) a portion of a compute device (e.g., less than the entirety of the compute device). In other implementations, the set of inputs can execute a software code or part of the software code. The inputs can be provided to the compute device 210 for self-integrity validation. Alternatively, the inputs can be provided to a remote compute device (not shown in FIG. 2) for integrity validation. The inputs can include code to be executed on the compute device. In one implementation, for example, a user or a test engineer can specify particular test inputs. Alternatively, the input vector manager 242 can have a predefined list of inputs and select them in a predefined order.

The side-channel information detector 244 can measure side-channel information (such as temperature, power, EM emissions, circuit delay, and/or the like) of the compute device 210 using one or more sensors (not shown in FIG. 2) under a given input or a set of given inputs. The sensors that can be used to capture side-channel information include, but are not limited to: acoustic and vibration detectors, temperature detectors, electro-magnetic (such as electric current (e.g. current probes, hall effect sensors, radio frequency (RF) transformers, current mirrors, shunt resistors, etc.) detectors, electric and magnetic flux detectors, electromagnetic radiation detectors, near-field radiation detectors, etc.), position detectors, distance detectors, angle detectors, speed detectors, acceleration detectors, light and optical detectors, environmental detectors: moisture, humidity, pressure, force, level, circuit delay, and/or the like. The given input or the set of given inputs can be provided by the input vector manager 242 of the compute device 210 itself or a remote compute device. In some implementations, a sensor (or a detector) can be remote from the authentication controller 240 and its detected sensor data can be sent to the side-channel information detector 244 for further processing.

The integrity validation analyzer 246 can perform different signal processing approaches to extract discriminatory features (also referred herein to as characteristics) from the side-channel information captured by the side-channel information detector 244 of the compute device 210 itself, or the side-channel information associated with a remote compute device. The integrity validation analyzer 246 can include an analog processor (not shown), an analog-to-digital converter (ADC) (not shown), and a digital signal processor (not shown) to process the measured side-channel information. For example, the integrity validation analyzer 246 can have the sensor/detector connected to the analog processor and/or to the ADC, which is in turn connected to the digital signal processor. The analog processor can receive the side-channel information from the sensor/detector and perform signal conditioning and processing (e.g., reducing extraneous information that need not be digitized) before sending the side-channel information to the ADC to convert the analog data to digital signals. The digital signal processor can receive the digital signals converted by the ADC and generate frequency domain signal components of the digitized signals for frequency domain analysis. The digitized signals can also be stored for later processing.

The integrity validation analyzer 246 can also extract discriminatory features from the side-channel information. Feature extraction can involve analysis, for example, of resonance frequencies, absorption frequencies, polarization, harmonic reflections, reflection arrival times, and/or signal strength. In some implementations, the integrity validation analyzer 246 can compare the discriminatory features of the received side-channel information with the discriminatory features of the predefined side-channel information of a known device (a known trusted/authorized device or a known counterfeit/unauthorized device). The integrity validation analyzer 246 can further generate a statistical analysis indicating the likelihood of the target device (i.e., the compute device being validated) is legitimate/authorized and/or functionally correct.

In some implementations, the authentication controller 240 can include a Physically Unclonable Function (PUF) (not shown in FIG. 2). The PUF is a challenge-response mechanism in which the mapping between a challenge and the corresponding response is dependent on the complex and variable nature of a physical material. The PUF can be any combination of hardware and/or software (stored and/or executing in hardware). The PUF can impact side-channel information or be more directly applied to determining a decryption key. In some situations, the PUF can facilitate with identifying counterfeit components or a specific authorized unit.

In use, in some situations, the compute device 210 can monitor itself for integrity validation. Specifically, the input vector manager 242 of the authentication controller 240 can provide inputs (or input vectors) for either electrical test or simulation test that activates the compute device 210 or specifically focuses on (or activates) a portion of a compute device 210. In some implementations, the input can activate software code or part of software code. The inputs can include code to be executed on the compute device. The side-channel information detector 244 measures the side-channel information of the compute device 210 in response to the inputs provided by the input vector manager 242. The side-channel information can be temperature, power, EM emissions, circuit delay, and/or the like associated with the compute device 210 detected by one or more sensors of side-channel information detector 244 under a given input or a set of given inputs. The measured side-channel information can be sent, by the side-channel information detector 244, to the integrity validation analyzer 246 for signal processing and analyzing. The integrity validation analyzer 246 extracts discriminatory features from the received side-channel information and compares the discriminatory features of the received side-channel information with the discriminatory features of the predefined side-channel information of a known device (a known trusted/authorized device or a known counterfeit/unauthorized device). The integrity validation analyzer 246 can further generate a statistical analysis indicating the likelihood of the compute device 210 being legitimate/authorized and/or functionally correct. In the even that an anomaly is detected, the compute device 210 can implement remedial processes, such as shutting down the compute device 210, notifying an entity of the anomaly, or resetting the compute device 210 to a known state.

In use, in other situations, the compute device 210 can validate a remote compute device commutatively coupled via a network. Specifically, the input vector manager 242 of the authentication controller 240 of the compute device 210 can send inputs (or input vectors) for either electrical test or simulation test that activates a remote compute device (not shown in FIG. 2). A side-channel information detector associated with the remote compute device measures the side-channel information of the remote compute device in response to such given inputs. The measured side-channel information of the remote compute device can then been sent to the integrity validation analyzer 246 of the compute device 210 for signal processing and analyzing. The integrity validation analyzer 246 extracts discriminatory features from the side-channel information associated with the remote compute device and compares the discriminatory features of the received side-channel information with the discriminatory features of the reference side-channel information of a known device (a known trusted/authorized device or a known counterfeit/unauthorized device). The integrity validation analyzer 246 can further generate a statistical analysis indicating the likelihood of the remote compute device being legitimate/authorized and/or functionally correct. Remedial actions (such as sending a signal from the compute device 210 to the remote compute device to shut down the remote compute device, to notify a third entity, or to reset the remote compute device to a known state) can be triggered when the remote compute device is determined to be unauthorized.

As shown in FIG. 2, the encryption and the decryption controller 250 includes a side-channel information detector 252, an encryption applicator 255, and a decryption applicator 256. In some implementations, the encryption and the decryption controller 250 includes a processor and a memory. In some implementations, the encryption and the decryption controller 250 can be a single physical device. In other implementations, the encryption and the decryption controller 250 can include multiple physical devices (e.g., operatively coupled by a network), each of which can include one or multiple modules and/or components shown in FIG. 2. In some implementations, the encryption applicator 255 can be operatively coupled to the side-channel information detector 252, and the decryption applicator 256 can be operatively coupled to the side-channel information detector 252. Each of the side-channel information detector 252, the encryption applicator 255, and the decryption applicator 256 in the encryption and the decryption controller 250 can be any combination of hardware and/or software (stored and/or executing in hardware) capable of performing one or more specific functions. Specially, the side-channel information detector 252 can include a physical hardware (e.g., sensor) to measure side-channel information (such as temperature, power, EM emissions, circuit delay, and/or the like) of the compute device 210.

The side-channel information detector 252 can be configured to measure side-channel information (such as temperature, power, EM emissions, circuit delay, and/or the like) of the compute device 210 using one or more sensors under a given input or a set of given inputs. The side-channel information can be measured when the processor 290 executes a first section of code from a set of sections of code. Such side-channel information represents a unique signature state (e.g., power) of the compute device 210 when the first section of code is executed. Therefore, only authorized compute device running only the proper software can decrypt such encrypted data. The given input or the set of given inputs can be provided by the input vector manager 242 of the compute device 210 itself or a remote compute device (not shown in FIG. 2). In some implementations, a sensor can be remote from the encryption and decryption controller 250 and its detected sensor data can be sent to the encryption applicator 255 or the decryption applicator 256 for further processing. The side-channel information detector 252 is functionally and/or physically similar to the side-channel information detector 244 at the authentication controller 240. In some implementations, the side-channel information detector 252 and the side-channel information detector 244 can be the same component (or sensor).

Before sending data to a remote device, the encryption applicator 255 can encrypt the data such that only an authorized remote device can decrypt the data for processing. During a data encryption process, the encryption applicator 255 can digitize and convert the measured side-channel information to an encryption key (e.g., numbers, letters, symbols) associated with a first section of code. The encryption applicator 255 can apply algorithms (e.g., Blowfish, Advanced Encryption Standard) to the measured side-channel information to produce the first encryption key. The encryption applicator 255 can encrypt a second section of code with the first encryption key to produce an encrypted second section of code. In some implementations, the encryption applicator 255 can obtain additional encryption key(s) (e.g., public key) and also encrypt the second section of code with additional encryption key(s). The encryption application 255 can continue to encrypt the next section of code using an encryption key derived from the side-channel information measured when the previous section of code is executed. When each section of code from a set of sections of code is encrypted, the encryption applicator 255 can aggregate each encrypted section of code and send to another compute device.

Upon receiving encrypted data from a remote device, during a data decryption process, the decryption applicator 256 can digitize and convert measured side-channel information to a decryption key when the processor 290 executes a first section of code of the encrypted data at the compute device 210. In some implementations, the decryption applicator 256 can apply algorithms (e.g., Blowfish, Advanced Encryption Standard) to the measured side-channel information to produce the first decryption key. In other implementations, the decryption key can be generated based on, for example, a rank ordering occupied energy channelization bins, ratio of key feature amplitudes, hash internal states of registers such as a sampling dynamic code analysis, or a mapping between side-channel information and the decryption key(s). The decryption applicator 256 can decrypt a second section of code with the first decryption key. In some implementations, the decryption applicator 256 can obtain additional decryption key(s) (e.g., public key) and also decrypt the second section of code with additional decryption key(s). When the first decryption key substantially matches the first encryption key encrypted on the second section of code, the second section of code is decrypted and the compute device can read (or execute) the second section of code. The first decryption key substantially matches the first encryption key when the differences of certain feature(s) in the first decryption key and the first encryption key are within a predefined range (e.g., a threshold). For example, the first decryption key substantially matches the first encryption key when the first decryption key (e.g., 3, 7, 9, 11, 13) overlaps 80% of the first encryption key (e.g., 3, 8, 9, 11, 13). The decryption applicator 256 can continue to decrypt the next section of code using a decryption key derived from the side-channel information measured when the previous section of code is executed. If each decryption key substantially matches each encryption key associated with the same section of code, the set of sections of code is decrypted.

In use, the compute device 210 encrypts data (e.g., a set of sections of code) using side-channel information and transmits the encrypted data to another compute device. Specifically, the processor 290 of the compute device 210 can execute a first section of code from the set of sections of code. The side-channel information detector 252 can measure the side-channel information in response to the execution of the first section of code. Such side-channel information represents a unique power signature state of the compute device 210 when the first section of code is executed. Therefore, only authorized compute device(s) can decrypt such encrypted data. The encryption applicator 255 can then convert the measured side-channel information to a first encryption key and encrypt a second section of code with the first encryption key to produce an encrypted second section of code. In some implementations, the encryption applicator 255 can obtain additional encryption key(s) (e.g., public key) and also encrypt the second section of code with additional encryption key(s). The processor 290 can then execute the second section of code. In some instances, the data include a set of sections of code and the order of the set of sections of code can be pre-defined to enable the processor 290 to execute each section of code according to the pre-defined order of the set of sections of code. The side-channel information detector 252 can measure the side-channel information in response to the execution of the second section of code. The encryption applicator 255 can convert the side-channel information to a second encryption key and encrypt a third section of code with the second encryption key to produce an encrypted third section code. The encryption applicator 255 aggregates the encrypted second section of code and the encrypted third section of code. The encryption and decryption controller 250 at the compute device 210 can be configured to repeat the above steps with each section of code until each section of code from a block of code is encrypted.

In another use, the compute device 210, upon receiving encrypted data (e.g., a set of sections of code) from a remote compute device, can decrypt the encrypted data for further execution. Specifically, the processor 290 of the compute device 210 can receive an indication of a pre-defined order of the set of sections of code from the remote compute device. The processor 290 can execute a first section of code from the set of sections of code according to the indication of the pre-defined order of the set of sections of code. The side-channel information detector 252 can measure side-channel information in response to the execution of the first section of code. The decryption applicator 256 can convert the side-channel information to a first decryption key and decrypt a second section of code with the first decryption key. In some implementations, the decryption applicator 256 can obtain additional decryption key(s) (e.g., public key) and also decrypt the second section of code with additional decryption key(s). When the first decryption key substantially matches the first encryption key encrypted on the second section of code, the second section of code is decrypted and the compute device can read (or execute) the second section of code. The processor 290 can execute the second section of code and the side-channel information detector 252 can measure the side-channel information in response to the execution of the second section of code. The decryption applicator 256 can convert the side-channel information to a second decryption key and decrypt a third section of code with the second decryption key. The encryption and decryption controller 260 can repeat the above steps with each section of code until each section of code from a block of code is decrypted.

In some situations, multiple execution paths can lead to the same section of code. The decryption key(s) can be derived from execution of a preceding section of code from any multiple execution path. For example, following the execution of section of code C1, sections of code C2 and C4 can be executed which leads to the execution of section of code C6. In an alternative execute path, following the execution of section of code C1, sections of code C3 and C5 can be executed which leads to the execution of the section of code C6. To derive a decryption key for the section of code C6, the side-channel information of either the section of code C4 or the section of code C5 can be used. The section of code C6 can be decrypted when the decryption key derived from either the section of code C4 or the section of code C5 substantially matches the encryption key encrypted on the section of code C6.

FIG. 3 is a flow chart illustrating a method to validate integrity of a remote device using side-channel information, according to one embodiment. The integrity validation of a remote device method 300 can be executed at, for example, an authentication controller such as the authentication controller 240 shown and described with respect to FIG. 2. In some instances, the authentication controller can send, from a first compute device, inputs (or input vectors) for either electrical test or simulation test that activates a second compute device (i.e., a remote compute device) at 302. The inputs can include code to be executed on the remote electronic device. A side-channel information detector associated with the second compute device measures the side-channel information of the second compute device in response to such given inputs. The measured side-channel information of the second compute device can then been sent to and received by an integrity validation analyzer of the first compute device for signal processing and analyzing at 304. The integrity validation analyzer of the first compute device extracts discriminatory features from the side-channel information associated with the second compute device and compares the discriminatory features of the received side-channel information with the discriminatory features of the predefined side-channel information of a known device (a known trusted/authorized device or a known counterfeit/unauthorized device) at 306. If the received side-channel information of the second compute device substantially matches the predefined side-channel information of a known trusted device at 308, the first compute device generates a message at 310 indicating that the integrity of the second compute device is validated. If the received side-channel information of the second compute device does not substantially match the predefined side-channel information of a known trusted device at 308, the first compute device generates a message at 312 indicating that the integrity of the second compute device is compromised. In such an event, remedial actions (such as sending a signal from the first compute device to the second compute device to shut down the second compute device, to notify a third entity, or to reset the second compute device to a known state) can be triggered. Optionally at 314, the first compute device can repeat with different input vectors to exercise various aspects of the hardware and/or software of the second compute device for forensic information of the anomaly.

FIG. 4 is a flow chart illustrating a method to encrypt data using side-channel information, according to an embodiment. When a compute device (such as the compute device 210 in FIG. 2) prepares to send data (e.g., a set of sections of code) to a remote device, the compute device encrypts the data using the data encryption method 400 such that only authorized remote device can read the data. The data encryption using side-channel information method 400 can be executed at, for example, an encryption and decryption controller such as the encryption and decryption controller 250 shown and described with respect to FIG. 2. In some embodiments, the encryption and decryption controller executes a first section of code from the set of sections of code at 402 according to an indication of a pre-defined order of the set of sections of code. A side-channel information detector of the encryption and decryption controller (such as the side-channel information detector 252 in FIG. 2) measures the side-channel information in response to the execution of the first section of code at 404. Such side-channel information represents a unique signature state (e.g., power) of a compute device when the first section of code is executed. An encryption applicator of the encryption and decryption controller (such as the encryption applicator 255 in FIG. 2) converts the measured side-channel information to a first encryption key at 406 and encrypts a second section of code with the first encryption key to produce an encrypted second section of code at 408. In some implementations, the encryption and decryption controller can optionally obtain additional encryption key(s) (e.g., public key) and also encrypt the second section of code with additional encryption key(s) at 410. In some implementations, the encryption and decryption controller can obtain device state information, such as, but not limited to, register settings and/or other memory content, in response to the execution of the first section of code. Such device state information represents a unique signature state of the compute device and can be converted to an encryption key. The encryption key can be similarly used to encrypt the second section of code.

The encryption and decryption controller executes the second section of code at 412. The encryption and decryption controller measures the side-channel information in response to the execution of the second section of code at 414. Next, the encryption and decryption controller converts the side-channel information to a second encryption key at 416 and encrypts a third section of code with the second encryption key to produce an encrypted third section code at 418. Similarly, the encryption and decryption controller can optionally obtain additional encryption key(s) (e.g., public key) and also encrypt the third section of code with additional encryption key(s) at 420. The encryption and decryption controller optionally aggregates the encrypted second section of code and the encrypted third section of code at 422 according to an indication of a pre-defined order of the set of sections of code. Similarly stated, the encryption and decryption controller optionally appends the encrypted third section of code to the encrypted second section of code at 422 to reassemble the entire code. The encryption and decryption controller can repeat steps 412-418 with each section of code until each section of code from a block of code is encrypted.

FIG. 5 is a flow chart illustrating a method to decrypt data using side-channel information, according to an embodiment. When a compute device (such as the compute device 210 in FIG. 2) receives encrypted data (e.g., an encrypted set of sections of code) from a remote device, the compute device decrypts the encrypted data using the data decryption method 500 for further processing. The data decryption using side-channel information method 500 can be executed at, for example, an encryption and decryption controller such as the encryption and decryption controller 250 shown and described with respect to FIG. 2. A compute device (such as the compute device 210 in FIG. 2), upon receiving encrypted data, executes a first section of code from the set of sections of code at 502 according to an indication of a pre-defined order of the set of sections of code. The indication of the pre-defined order of the set of sections of code can be received from the remote device. A side-channel information detector of the encryption and decryption controller (such as the side-channel information detector 252 in FIG. 2) measures side-channel information in response to the execution of the first section of code at 504. A decryption applicator of the encryption and decryption controller (such as the decryption application 256 in FIG. 2) converts the side-channel information to a first decryption key at 506 and decrypts a second section of code with the first decryption key at 508. In some implementations, the decryption applicator can optionally obtain additional decryption key(s) (e.g., public key) and also decrypt the second section of code with additional decryption key(s) at 510. When the first decryption key substantially matches the first encryption key encrypted on the second section of code, the second section of code is decrypted and the compute device can read (or execute) the second section of code. The compute device executes the second section of code at 512 and the side-channel information detector measures the side-channel information in response to the execution of the second section of code at 514. The decryption applicator converts the side-channel information to a second decryption key at 516 and decrypt a third section of code with the second decryption key at 518. Similarly, the decryption applicator can obtain additional decryption key(s) (e.g., public key) and also optionally decrypt the third section of code with additional decryption key(s) at 520. The encryption and decryption controller repeats steps 512-518 with each section of code until each section of code from a block of code is decrypted. In some situations, multiple execution paths can lead to the same section of code. The encryption and decryption controller derives decryption key(s) from execution of a proceeding section of code from any multiple execution path. For example, following the execution of section of code C1, the compute device executes sections of code C2 and C4 which leads to the execution of section of code C6. In an alternative execute path, following the execution of section of code C1, the compute device executes sections of code C3 and C5 which also leads to the execution of the section of code C6. To derive a decryption key for the section of code C6, the side-channel information of either the section of code C4 or the section of code C5 can be used. The encryption and decryption controller decrypts the section of code C6 when the decryption key derived from either the section of code C4 or the section of code C5 substantially matches the encryption key encrypted on the section of code C6.

Power Signature Analysis

A power signature analysis system, such as the authentication controller 240 shown and described with respect to FIG. 2, comprises three main elements common to all pattern recognition systems: sensing, feature extraction, and detection/classification. Power signature signals can be collected from an electronic device when the electronic device is operating (e.g., locally powered on) and/or when the electronic device is not operating (e.g., locally powered off). In some embodiments, when an excitation source, for example a Radio Frequency (RF) emitter, an electromagnetic interference (EMI) pulse, a white noise signal, a wide-band signal, and/or a frequency-swept signal, is applied to a target electronic device, an electromagnetic field(s) and/or wave(s) can be induced, reflected back, and/or absorbed by the target electronic device. Power is altered during the reflection of the EM field and/or wave(s) by the target electronic device. The propagated EM signals (thus the renewed power) vary depending on the integrity of the integrated circuits and/or electronic components within the target electronic device. In some instances, different components within the electronic device (such as processors, memories, circuit boards, etc.) can have different propagated EM signals (thus the received power). In some instances, when the components within the target electronic device are trusted components, the propagated EM signals (thus the received power) can vary based on the design (or arrangement) of the components within the target electronic device, which can indicate the counterfeit status of the target electronic device. Therefore, by measuring the propagated EM signals (or emission signals) from a target electronic device and comparing that with reference power signature signals from reference device(s) (e.g., pre-determined trusted devices, and/or pre-determine counterfeit devices), the integrity of the integrated circuits and/or electronic components within the target electronic device (e.g., the counterfeit status of the target electronic device) can be determined.

Characterization

The characterization process involves collecting and characterizing reference power signature signals of reference devices by repeatedly applying excitation to the reference devices (e.g., pre-determined trusted devices, and/or pre-determined counterfeit devices) in a controlled environment (including setting inputs used during excitation, and helping synchronizing traces). For better performance, the characterization should be an iterative, interdependent process. There are several options to facilitate and enhance the generation of reference power signature data including: crowd sourcing (e.g., by obtaining numerous references from multiple sources to define what is a power signature of a reference device), machine learning in the field (repeated observations of a power trace to define what historically constitutes a power signature of a reference device), and/or the like. For example, the reference power signature data generation can include crowd source pre-determined counterfeit devices.

Trace Processing And Feature Extraction

The process of preparing test traces (i.e., power signature signals of target devices) to be compared with the stored reference power signature signals is referred to herein as preprocessing and feature extraction. Trace preprocessing involves general tasks to condition the traces to extract the selected discriminatory features (or characteristics), e.g., converting the traces to the appropriate domain or aligning the traces in reference to a specific marker.

Another example of basic preprocessing is to align time-domain traces before being passed to a correlation detector. Time alignment of traces can be achieved with a correlation detector. In some instances, the correlation detector can be disposed within an authentication controller such as the authentication controller 240 shown and described with respect to FIG. 2. The correlation detector can be any hardware and/or software module (stored in a memory such as the memory 292 in FIG. 2 and/or executing in hardware such as the processor 290 in FIG. 2).

In this example, each trace of N samples is considered as a point in a multidimensional Euclidean space. Feature extraction is the process of calculating the final test statistic (or discriminatory feature) from new traces which is passed to the detectors and used to determine integrity. This process is unique to each selected feature. For example, in basic time domain correlation analysis, preprocessing could include coarse synchronization and compensation for specific platform or packaging characteristics, while feature extraction involves comparing against the stored signature by calculating the correlation factor or the Euclidean distance.

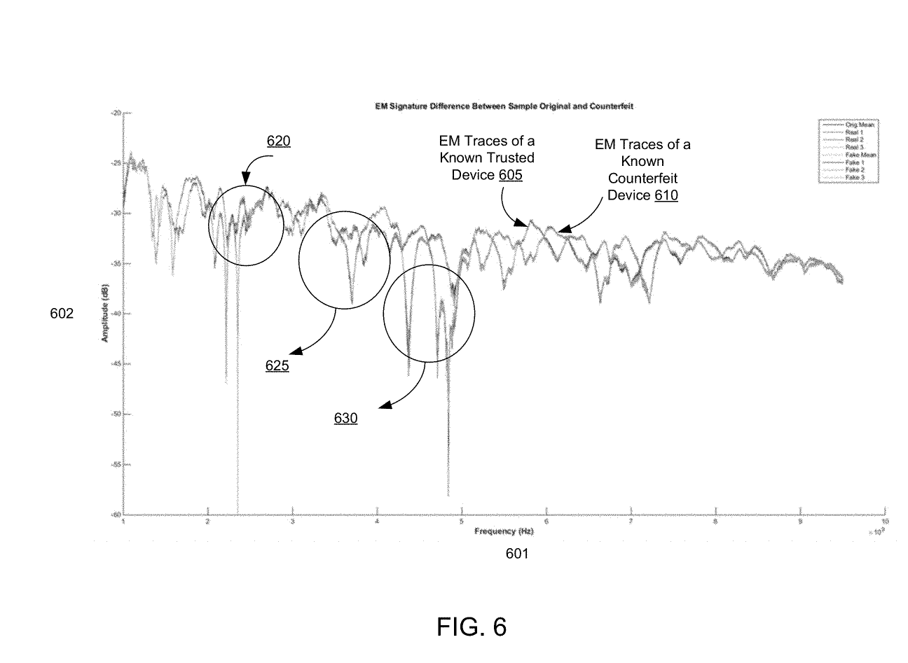

For example, FIG. 6 is a graph showing measured electromagnetic (EM) emission signals (also referred to herein as “traces”) from a pre-determined (or known) trusted device and a pre-determined (or known) counterfeit device, according to an embodiment. A set of EM traces measured from a known trusted device 605 at different times shows amplitude changes 602 over frequency 601. A set of EM traces measured from a known counterfeit device 610 at different times shows amplitude changes 602 over frequency 601. The set of EM traces from the known counterfeit device 610, however, exhibits behaviors distinct from the behaviors of the set of EM traces from the known trusted device 605.

As shown in FIG. 6, the set of EM traces from the known trusted device 605 and the set of EM traces from the known counterfeit device 610 have been preprocessed. Specifically, the EM traces, 605 and 610, have been converted to the frequency domain 601. The set of EM traces from the known trusted device 605 and the set of EM traces from the known counterfeit device 610 have also been synchronized for the following feature extraction. Feature extraction involves extracting discriminatory features from the two sets of EM traces and comparing the discriminatory features to determine if a device is a counterfeit device. As shown in FIG. 6, discriminatory features at, for example, 620, 625, and 630 from the two sets of EM traces can be desirable to extract because they show distinct divergences between the two sets of EM traces.

In use, a target device with unknown counterfeit status can be measured by an authentication controller (such as the authentication controller 240 shown and described with respect to FIG. 2.) A set of EM traces from the target device can be compared with a set of EM traces from a known trusted device. If no substantial divergence is found between the discriminatory features of the set of EM traces from the target device and the known trusted device, the target device can be determined to be trusted. On the other hand, if significant divergence (e.g., divergence exceeding a predefined threshold) is found between the discriminatory features of the set of EM traces from the target device and the known trusted device, the target device can be determined (or identified) to be a counterfeit device. Moreover, the set of EM traces from the target device can be compared with a set of EM traces from a known counterfeit device. If no significant divergence (e.g., divergence exceeding a predefined threshold) is found between the discriminatory features of the set of EM traces from the target device and the known counterfeit device, the target device can be determined to be counterfeit. On the other hand, similarly, if significant divergence is found between the discriminatory features of the set of EM traces from the target device and the known counterfeit device, the authentication controller can proceed to compare the EM traces from the target device with the EM traces from other known counterfeit devices until a determination, with certain confidence level, on the counterfeit status of the target device can be made.

Detector Characteristics

Once the power signature signals have been extracted and the discriminatory features have been selected, the next step in the power signature analysis process is to design optimal detectors to perform the final integrity assessment. In some embodiments, the detector design is performed in advance to the integrity validation process (such as the integrity validation process of a remote device described in FIG. 3) such that the reference data from the pre-determined trusted devices (and/or pre-determined counterfeit devices) have been collected and processed prior to testing the target electronic devices. These detectors can make the final decision of whether a target electronic device should be considered a counterfeit. The process of detector design and normal monitoring operation are very similar. In detector design, the EM emission signals from the pre-determined trusted devices (and/or pre-determined counterfeit devices) are captured and processed to extract the selected discriminatory features and compared against the stored signatures. Several traces are collected and processed and their statistical sample distributions are used to identify a threshold that yields the expected performance targets.

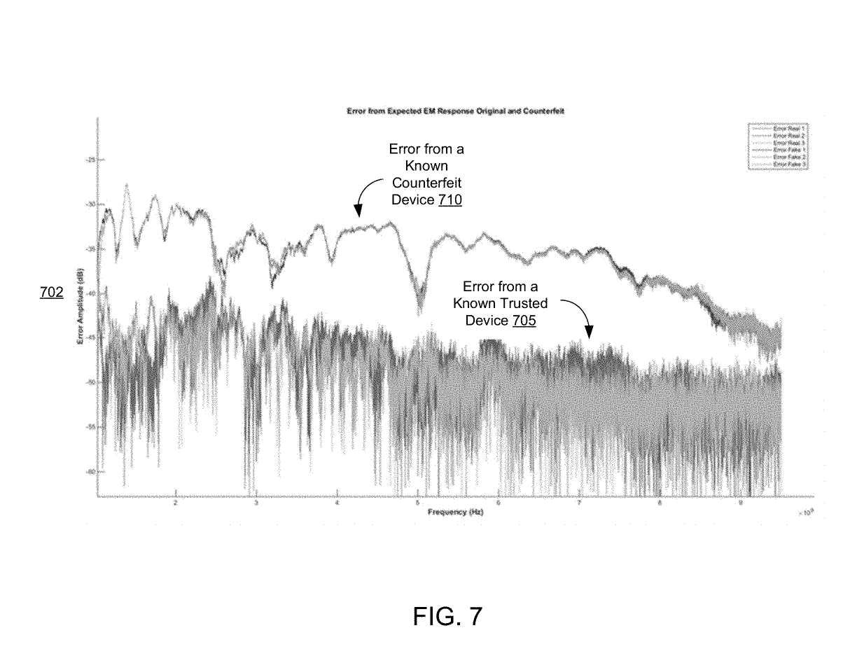

FIG. 7 is a graph showing error signals between an expected response and an observed response for a known trusted device and a known counterfeit device, according to an embodiment. The graph shows the error amplitude in dBs 702 of the reflected EM traces measured from the known trusted device 705 and the counterfeit device 710, versus frequency in Hz. As FIG. 7 shows, the error signals 702 for the known counterfeit device 710 are separated from the error signals 702 for the known trusted device 705, allowing for identification of other counterfeit devices, distinct from the known trusted device 705, according to the apparatus and method described herein.

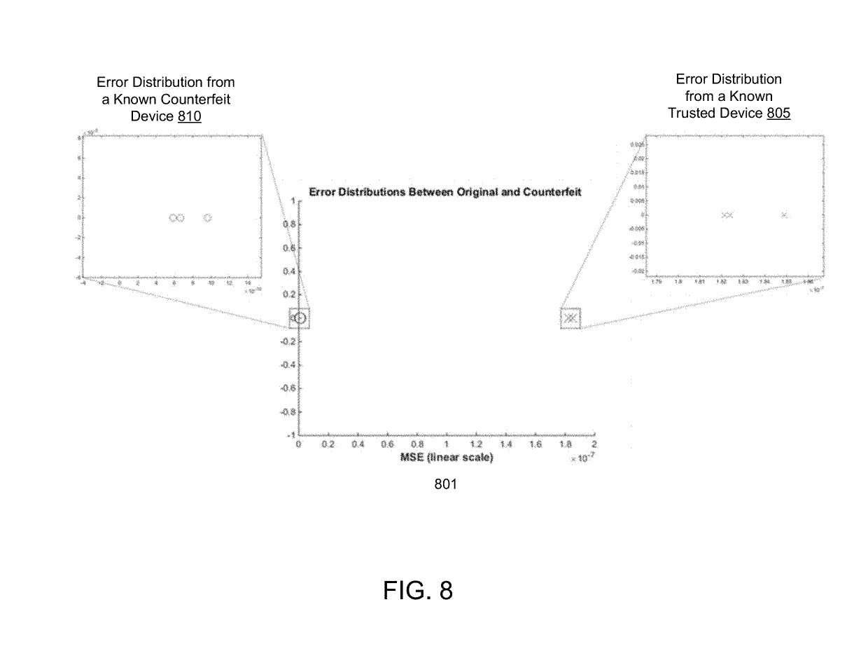

FIG. 8 is a graph showing error distributions of a known trusted device 805 and a known counterfeit device 810, according to an embodiment. Using a difference vector, the final test statistic or discriminatory feature passed to the detector can be represented by the mean squared error (MSE) 801 or any other distance or error metric. Several traces are collected and processed and their statistical sample distributions are used to identify a threshold that yields the expected performance targets. Again, due to the separation between the error distribution for the known counterfeit device 810 and the error distribution for the known trusted device 805, identification of other counterfeit devices, distinct from the known trusted device 805 can be performed.

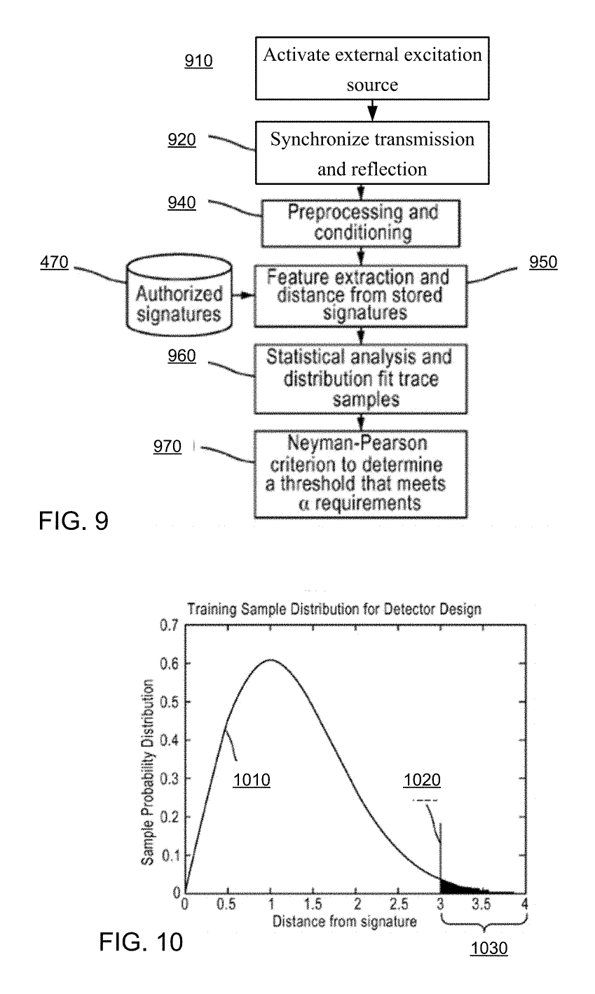

An example of the process of detector design is shown in FIG. 9. An external excitation source is activated at 910. The parameters of the excitation source and the power signature detector are synchronized at 920, and the traces are preprocessed and conditioned at 940. Using authorized signatures at 470 for comparison, the selected discriminatory features are extracted and a distance metric is generated at 950. Then statistical analysis and distribution fitting is done at 960 on the resulting metrics. Finally, the Neyman-Pearson criterion is applied at 970 to determine a threshold that meets expected performance targets.

A common approach to design optimal detectors involves the application of the Neyman-Pearson criterion to maximize the probability of detection for a given probability of false alarm. As a brief reminder of this criterion, which is spawned from basic hypothesis testing theory, a target probability of false alarm is set based on the tolerance and estimated cost of making a mistake in the final decision. Using an estimate of the probability distribution of the discriminatory features from the pre-determined trusted devices (and/or pre-determined counterfeit devices), a distance threshold is calculated that yields the expected probability of false alarm while maximizing the probability of correct detection. An example of this process is shown in FIG. 10, in which a distance threshold 1020 is calculated for a probability distribution 1010 that yields an expected probability of false alarms 1030.

There are different techniques that can yield improved results depending on the nature of the selected discriminatory features. Other techniques for detector design and machine training include: Neural Networks, Support Vector Machines, and Hidden Markov Models.

It is intended that the systems and methods described herein can be performed by software (stored in memory and/or executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including Unix utilities, C, C++, Java™, JavaScript (e.g., ECMAScript 6), Ruby, SQL, SAS®, the R programming language/software environment, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein. Each of the devices described herein, for example, the excitation controller 230, the receiver controller 240, the feature extraction engine 250, and the analyzer 260, can include one or more memories and/or computer readable media as described above.

While various embodiments have been described above, it should be understood that they have been presented by way of example only, and not limitation. Where methods and steps described above indicate certain events occurring in certain order, the ordering of certain steps may be modified. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein. Furthermore, although various embodiments are described as having a particular entity associated with a particular compute device, in other embodiments different entities can be associated with other and/or different compute devices.

1. An apparatus, comprising:
a memory of a first compute device; and
a processor of the first compute device, the processor communicatively coupled to the memory,
the processor configured to send, from a first compute device, input vectors to a second compute device operatively coupled to the first compute device,
the processor configured to receive first side-channel information, from the second compute device, in response to sending the input vectors,
the processor configured to compare the first side-channel information with second side-channel information,
the processor configured to generate a message notifying an anomaly of the second compute device in response to the first side-channel information not substantially matching the second side-channel information.

2. The apparatus of clam 1, wherein the second side-channel information is predefined and generated by a compute device of a type that correspond to a type of the second compute device.

3. The apparatus of claim 1, wherein the second side-channel information is generated by the first compute device executing the input vectors, the first compute device being a type that corresponds to a type of the second compute device.

4. The apparatus of claim 1, wherein:
the processor is configured to send the input vectors to the second compute device to cause the second compute device to execute a portion of the second compute device,
the processor is configured to receive the first side-channel information which is side-channel information detected during execution of the portion of the second compute device.

5. The apparatus of claim 1, wherein:
the input vectors include software code,
the processor is configured to send the input vectors to the second compute device to cause the second compute device to execute at the second compute device the software code associated with the input vectors,
the processor is configured to receive the first side-channel information which is side-channel information detected during execution of the software code.

6. The apparatus of claim 1, wherein:
the input vectors include a first segment of software code and a second segment of software code,
the processor configured to execute the first segment of software code to produce the second side-channel information,
the processor configured to produce an encryption key based on the second side-channel information, and
the processor configured to encrypt the second segment of software code based on the encryption key.

7. A non-transitory medium storing code representing a plurality of processor-executable instructions, the code comprising code that causes a processor to:
execute, at a first compute device that includes the processor, a first segment of software code to produce a side-channel information of the first compute device;
produce an encryption key based on the side-channel information of the first compute device;
encrypt a second segment of software code based on the encryption key to produce an encrypted version of the second segment of software code; and
send, from the first compute device to a second compute device operatively coupled to the first compute device, the first segment of software code and the encrypted version of the second segment of software code without sending the encryption key such that the second compute device executes the first segment of software code to produce a side-channel information of the second compute device and produces a decryption key based on the side-channel information of the second compute device and such that second compute device attempts to decrypt the encrypted version of the second software code based on the decryption key to produce a potentially decrypted version of the second software code.

8. The non-transitory medium of claim 7, wherein the code to send includes code to send to cause the second compute device to detect an anomaly at the second compute device when the attempt by the second compute device fails to decrypt the second segment of software code, the decryption key not substantially matching the encryption key.

9. The non-transitory medium of claim 7, wherein the code to send includes code to send to cause the second compute device to detect a lack of an anomaly at the second compute device when the attempt by the second compute device succeeds to decrypt the second segment of software code, the encryption key substantially matching the decryption key.

10. The non-transitory medium of claim 7, wherein the side-channel information of the first compute device is a first side-channel information of the first compute device, the side-channel information of the second compute device is a first side-channel information of the second compute device, the encryption key is a first encryption key, the decryption key is a first decryption key, the code further comprising code that causes the processor to:
execute, at the first compute device, the second segment of software code to produce a second side-channel information of the first compute device;
produce a second encryption key based on the second side-channel information of the first compute device;
encrypt a third segment of software code based on the second encryption key to produce an encrypted version of the third segment of software code; and
send, from the first compute device to the second compute device, the encrypted version of the third segment of software code without sending the second encryption key such that the second compute device executes the potentially decrypted version of second segment of software code to produce a second side-channel information of the second compute device and produces a second decryption key based on the second side-channel information of the second compute device and such that second compute device attempts to decrypt the encrypted version of the third software code to produce a potentially decrypted version of the third software code.

11. The non-transitory medium of claim 10, wherein:
the code to send the first segment of software code and the encrypted version of the second segment of software code includes code to send to cause the second compute device to detect an anomaly at a first time at the second compute device when the attempt by the second compute device fails to decrypt the second segment of software code, and
the code to send the encrypted version of the third segment of software code includes code to send to cause the second compute device to detect an anomaly at a second time at the second compute device when the attempt by the second compute device fails to decrypt the third segment of software code.

12. The non-transitory medium of claim 10, wherein the first compute device and the second compute device are included within a common device.

13. A non-transitory medium storing code representing a plurality of processor-executable instructions, the code comprising code that causes a processor to:
receive, from a first compute device and at a second compute device that includes the processor and that is operatively coupled to the first compute device, a first segment of software code and an encrypted version of a second segment of software code without receiving an encryption key used to encrypt the second segment of software code at the first compute device;
execute the first segment of software code to produce a side-channel information of the second compute device;
produce a decryption key based on the side-channel information of the second compute device; and
attempt to decrypt the encrypted version of the second software code based on the decryption key to produce a potentially decrypted version of the second software code.

14. The non-transitory medium of claim 13, wherein the code to receive includes code to receive the encrypted version of the second segment of software code that was encrypted by the first compute device using the encryption key that was produced by the first compute device based on side-information of the first compute device produced during execution of the first segment of software code.

15. The non-transitory medium of claim 13, the code further comprising code to cause the processor to:
detect an anomaly at the second compute device when the attempt by the second compute device fails to decrypt the second segment of software code, the decryption key not substantially matching the encryption key.

16. The non-transitory medium of claim 13, the code further comprising code to cause the processor to:
detect a lack of an anomaly at the second compute device when the attempt by the second compute device succeeds to decrypt the second segment of software code, the encryption key substantially matching the decryption key.

17. The non-transitory medium of claim 13, wherein the side-channel information of the second compute device is a first side-channel information of the second compute device, the encryption key is a first encryption key, the decryption key is a first decryption key, the code further comprising code that causes the processor to:
receive, from the first compute device and at the second compute device, an encrypted version of a third segment of software code without receiving a second encryption key used to encrypt the encrypted version of the third segment of the software code;
execute the potentially decrypted version of second segment of software code to produce a second side-channel information of the second compute device;
produce a second decryption key based on the second side-channel information of the second compute device; and
attempt to decrypt the encrypted version of the third software code to produce a potentially decrypted version of the third software code.

18. The non-transitory medium of claim 17, wherein the code to receive includes code to receive the encrypted version of the third segment of software code that was encrypted by the first compute device using the second encryption key that was produced by the first compute device based on a second side-information of the first compute device produced during execution of the second segment of software code.

19. The non-transitory medium of claim 17, the code further comprising code to:
detect an anomaly at a first time at the second compute device when the attempt by the second compute device fails to decrypt the second segment of software code, and
detect an anomaly at a second time at the second compute device when the attempt by the second compute device fails to decrypt the third segment of software code.

20. The non-transitory medium of claim 17, the code further comprising code to:
receive, from the first compute device, a signal indicating a predefined order representing an order in which the first compute device encrypted the second segment of the software code and the third segment of software code based on the first segment of the software code and the second segment of the software code, respectfully,
the processor executing the code to execute the first segment of software code and the code to execute the potentially decrypted version of second segment of software code in an order defined by the predefined order,
the processor executing the code to produce the first decryption key and the code to produce the second decryption key in an order defined by the predefined order,
the processor executing the code to attempt to decrypt the encrypted version of the second software code and the code to attempt to decrypt the encrypted version of the third software code in an order defined by the predefined order.
